(19) United States
(12) Patent Application Publication
(10) Pub. No.: US 2021/0117096 A1
(43) Pub. Date: Apr. 22, 2021

(54) METHOD, DEVICE AND COMPUTER PROGRAM PRODUCT FOR BACKUPING DATA

(71) Applicant: EMC IP Holding Company LLC, Hopkinton, MA (US)

(72) Inventors: Jingrong Zhao, Chengdu (CN); Qingxiao Zheng, Chengdu (CN)

(21) Appl. No.: 16/862,478

(22) Filed: Apr. 29, 2020

(30) Foreign Application Priority Data
Oct. 17, 2019 (CN) 201910989181.8

(51) Int. Cl. G06F 3/06; G06F 16/245; G06F 16/2455

(52) U.S. Cl. CPC G06F 3/065; G06F 3/0619; G06F 16/24552; G06F 3/067; G06F 16/245; G06F 3/0641

(57) ABSTRACT

Embodiments of the present disclosure relate to a method, device and computer program product for backing up data. The method comprises determining, for a data backup to be performed, a first deduplication rate related to a first target server and a second deduplication rate related to a second target server. The method comprises selecting a suitable target server from the first target server and the second target server according to the first deduplication rate and the second deduplication rate. In addition, the method further comprises replicating a portion of data in the data backup to the selected suitable target server.

### CROSS-REFERENCE TO RELATED APPLICATIONS

This application claims priority to Chinese Application No. 201910989181.8 filed on Oct. 17, 2019. Chinese Application No. 201910989181.8 is hereby incorporated by reference in its entirety.

### FIELD

Embodiments of the present disclosure generally relate to the field of data storage, and more specifically to a method, device and computer program product for backing up data.

### BACKGROUND

In order to avoid data loss, users usually store files and data in a backup system, and the backup system is capable of storing a large amount of data. In the event of a data failure or disaster, data can be restored through the backup system to avoid unnecessary losses. Backup types of data backup may be classified as a full backup, an incremental backup, a differential backup and a selective backup. Data backup may be classified into a hot backup and a cold backup according to whether the system is in normal operation.

Hashing is a method of creating small digital fingerprints from any data. A hash algorithm encodes the data chunks into a digest, which makes the data amount smaller and has an identification function. For a certain data chunk, its hash value may be determined by the hash algorithm, and the hash value may uniquely represent the certain data chunk. The hash value is usually represented by a short character string composed of random letters and numbers.

### SUMMARY

Embodiments of the present disclosure provide a method, device and computer program product for backing up data. Embodiments of the present disclosure can reduce the amount of data transmitted during the data backup by selecting the most suitable target server from a plurality of target servers through data mining, thereby reducing the time for data replication and reducing the load and maintenance cost of the backup system.

In one aspect of the disclosure, there is provided a method for backing up data. The method comprises determining, for a data backup, a first deduplication rate related to a first target server and a second deduplication rate related to a second target server. The method further comprises selecting a target server from the first target server and the second target server based on the first deduplication rate and the second deduplication rate, and replicating a portion of data in the data backup to the selected target server.

According to another aspect of the present disclosure, there is provided an electronic device. The device comprises a processing unit and a memory coupled to the processing unit and storing instructions thereon. The instructions, when executed by the processing unit, perform the acts of determining, for a data backup, a first deduplication rate related to a first target server and a second deduplication rate related to a second target server. The acts further comprises selecting a target server from the first target server and the second target server based on the first deduplication rate and the second deduplication rate, and replicating a portion of data in the data backup to the selected target server.

According to a further aspect of the present disclosure, there is provided a computer program product that is tangibly stored on a non-transitory computer readable medium and includes machine-executable instructions. The machine-executable instructions, when executed, cause a computer to execute the method or process according to embodiments of the present disclosure.

This Summary is provided to introduce a selection of concepts in a simplified form that are further described below in the Detailed. Description. This Summary is not intended to identify key features or essential features of the claimed subject matter, nor is it intended to be used to limit the scope of the claimed subject matter.

### BRIEF DESCRIPTION OF THE DRAWINGS

The above and other features, advantages and aspects of embodiments of the present disclosure will be made more apparent by describing the present disclosure in more detail with reference to figures. In the figures, the same or like reference signs represent the same or like elements, wherein,

FIG. 1 shows a schematic diagram of using hashes to share the same data chunks;

FIG. 2 shows a schematic diagram of a schematic backup environment for data backup;

FIG. 3 shows a flowchart of a data backup method based on data mining according to an embodiment of the present disclosure;

FIG. 4 shows a schematic diagram of querying for hashes according to an embodiment of the present disclosure;

FIG. 5 shows a schematic diagram of data backup based on data mining according to an embodiment of the present disclosure;

FIG. 6 shows a timing diagram of a data backup process according to an embodiment of the present disclosure; and

FIG. 7 shows a schematic block diagram of a device that may be used to implement embodiments of the present disclosure.

### DETAILED DESCRIPTION OF EMBODIMENTS

Preferred embodiments of the present disclosure will be described below in more detail with reference to figures. Although figures show preferred embodiments of the present disclosure, it should be appreciated that the present disclosure may be implemented in various forms and should not be limited by embodiments stated herein. On the contrary, these embodiments are provided to make the present disclosure more apparent and complete, and to convey the scope of the present disclosure entirely to those skilled in the art.

As used herein, the term “includes” and its variants are to be read as open terms that mean “includes, but is not limited to.” Unless otherwise specified, the term “or” represents “and/or”. The term “based on” is to be read as “based at least in part on.” The term “an implementation” is to be read as “at least one implementation.” The term “another implementation” is to be read as “at least one other implementation.” Terms “first” and “second” may refer to different or identical objects, unless otherwise it is explicitly specified that they refer to different objects.

In a traditional data backup process, when there are a plurality of target backup servers, data backups are usually replicated to a certain target backup server according to the fixed setting or random setting of an administrator and/or user. For example, for a certain backup task to be performed, a deduplication rate between the backup task and the data on the target backup server is usually queried, and then data that does not exist on the target backup server will be replicated to the target backup server.

However, in some cases, the data deduplication rate between the data to be backed up and a designated target backup server is very low, whereas the data deduplication rate between the data to be backed up and another target backup server might be high. However, according to the traditional backup method, the backup data is still replicated to a designated target backup server without performing any data mining or analysis. This will cause excessive data transmission, not only increasing the time for data backup, but also increasing system loads and maintenance costs of the backup system.

To this end, embodiments of the present disclosure propose a new solution for selecting a more suitable target backup server based on data mining. Embodiments of the present disclosure may reduce the amount of data replicated during the data backup by selecting the most suitable target server from a plurality of target servers through data mining, thereby reducing the time for data replication and reducing the load and maintenance cost of the backup system. In some embodiments of the present disclosure, replication groups can be determined in a hash-based backup system, thereby implementing efficient backup data mining.

According to some embodiments of the present disclosure, adaptive processing is performed for the garbage collection function in the backup system, thereby improving the compatibility of the solutions of the embodiments of the present disclosure. In addition, according to some embodiments of the present disclosure, after the most suitable target server for each backup is determined, changes in the hashes of the data chunks to be replicated are dynamically reflected to a cache, thereby further saving storage space. In addition, the replication granularity of the embodiments of the present disclosure is one backup (for example, one backup task), rather than all backups of each client, which is conducive to the integrity of the backup data as well as data deduplication and easy implementation.

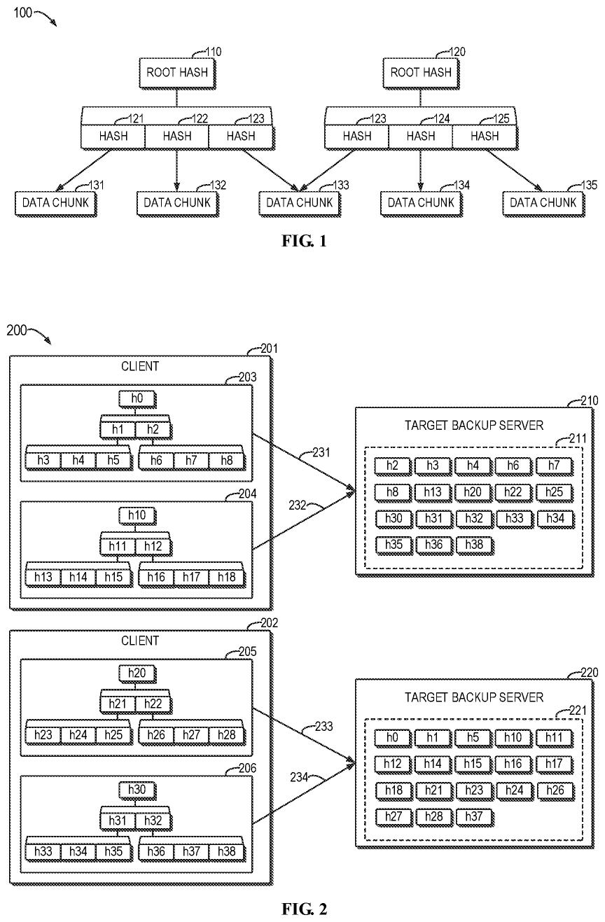

The basic principle and several example implementations of the present disclosure are illustrated below with reference to FIG. 1 through FIG. 7. It should be understood that these exemplary embodiments are given only to enable those skilled in the art to better understand the embodiments of the present disclosure without limiting the embodiments of the present disclosure in any way.

FIG. 1 shows a schematic diagram 100 of using hashes to share the same data chunks. In a hash-based backup system, source data of the backup will be divided into a plurality of data chunks according to some chunking algorithm, then those data chunks along with their mapping unique hashes will be saved in the backup system, where the presence of the hash means the presence of the related data chunk. As shown in FIG. 1, the data in the first backup is divided into data chunks 131, 132 and 133, and the data in the second backup is divided into data chunks 133, 134 and 135. Then, it is determined according to the hash algorithm that the hashes of the data chunks 131, 132 and 133 in the first backup are hashes 121, 122 and 123, respectively, and hashes of the data chunks 133, 134 and 135 in the second backup are hashes 123, 124, 125, respectively.

Refer to FIG. 1, for the first backup, a root hash 110 is obtained by hashing hashes 121, 122 and 123, and the hashes 121, 122 and 123 are hash values of data chunks 131, 132 and 133, respectively. Similarly, for the second backup, its root hash 120 is obtained by hashing hashes 123, 124, 125, and hashes 123, 124, 125 are hash values of data chunks 133, 134 and 135, respectively. As shown in FIG. 1, the first backup and the second backup both refer to the same data chunk 133, but only one copy of the data chunk 133 is saved on the disk. In this way, disk space in the backup system may be saved. In other words, by splitting data chunks and calculating the corresponding hash values, the same data chunk is stored only once in the same backup system.

FIG. 2 shows a schematic diagram of a schematic backup environment 200 for data backup. Generally speaking, the replication function in a backup system is mainly for disaster recovery, and it usually replicates backups from the source backup server to the target backup servers periodically. If any error or fault that causes data lost or data unusable occurs on the source backup server, the user may restore data from the target backup servers.

As shown in FIG. 2, the schematic the backup environment 200 includes clients 201 and 202 and target backup servers 210 and 220. The clients 201 and 202 may be located on the same server, and be referred to as a source backup server or a source server. Alternatively, the clients 201 and 202 may also be located on different servers. It should be understood that although only two clients and two target backup servers are shown in the schematic backup environment 200 of FIG. 2, the backup environment 200 may include more clients and/or target backup servers.

Refer to FIG. 2, the client 201 includes data backups 203 and 204 to be performed, where the hash of the data chunk in the data backup 203 is represented as h0-h8, and the hash of the data chunk in the data backup 204 is represented as h10-h18. Similarly, the client 202 also includes data backups 205 and 206 to be performed, where the hash of the data chunk in the data backup 205 is represented as h20-h28, and the hash of the data chunk in the data backup 206 is represented as h30-h38. At the current time, there is already some data on the target backup server 210, where the hash of the data chunk is a hash set 211, and there is also some data on the target backup server 220, where the hash of the data chunk is a hash set 221. During replication of the data backup, the data chunks corresponding to the hashes that already exist in the target backup server need not be replicated, thereby reducing the amount of data replicated during the data backup process.

In the traditional backup methods, the existing hashes in each target backup server are not aggregated and analyzed. By contrast, fixed target backup servers are usually set in the traditional backup methods. As shown in FIG. 2, all backups on the client 201 are fixedly set to be replicated to the target backup server 210, that is, the backup 203 will be replicated to the target backup server 210 as shown by the arrow 231, and the backup 204 will also be replicated to the target backup server 210 as shown by arrow 232. All backups on the client 202 are fixedly set to be replicated to the target backup server 220, that is, the backup 205 will be replicated to the target backup server 220 as shown by arrow 233, and the backup 206 will also be replicated to the target backup server 220 as shown by arrow 234. However, this traditional backup method will cause too much data to be replicated. For example, for the backup 204, its hash identical with the target backup server 210 is only h13, which means that the data chunks corresponding to other hashes in backup 204 need to be replicated to the target backup server 210, which seriously affects the performance of the backup system.

It can be seen that in the traditional backup methods, the backups are usually grouped by the clients, and the replication group that specifies the source backup server and the target backup server is usually specified by the administrator. When the scheduled replication time is reached, the source backup server replicates the client's new backup data to the target backup server. When needed, data may be restored from the target backup server to the source backup server. Although the traditional method may also achieve disaster recovery, the performance of the system is severely affected. Backup systems work separately with each other, and backup data are forcedly replicated to the specified target backup server. In the example of FIG. 2, more than half of the data chunks in the client 201 need to be replicated to the target backup server 210. Similarly, more than half of the data chunks in the client 202 need to be replicated to the target backup server 220. Therefore, the replication grouping in the traditional backup method is unreasonable and inefficient, and it does not consider how many identical data chunks exist on each target backup server, which wastes a lot of storage space.

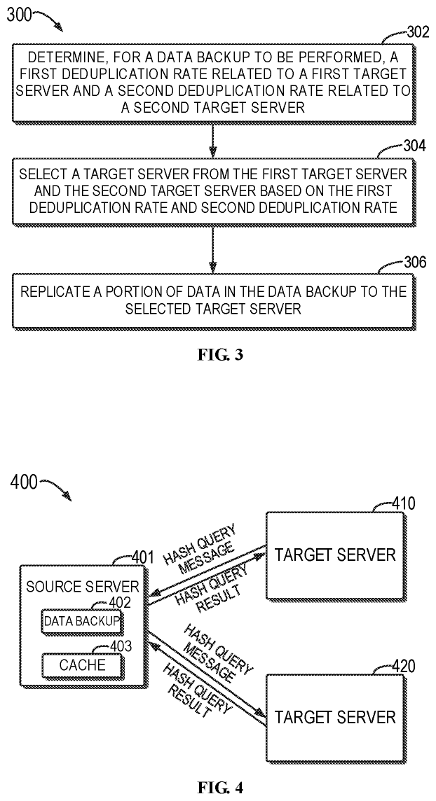

FIG. 3 shows a flowchart of a data backup method 300 based on data mining according to an embodiment of the present disclosure. To better describe the method 300, reference is made here to the example backup environment 200 as described in FIG. 2.

At 302, for the data backup to be performed, a first deduplication rate related to a first target server and a second deduplication rate related to a second target server are determined. For example, for the backup 204 of the example backup environment 200 in FIG. 2, it may be determined that the same hash between the hash of each data chunk in the backup 204 and the hash set 211 in the target backup server 210 is h13, and the same hashes between the hash of each data chunk in the backup 204 and the hash set 221 in the target backup server 220 are h10, h11, h12, h14, h15, h16, h17 and h18. Thus, it is possible to determine the first deduplication rate between the backup 204 and the data in the target backup server 210, and determine the second deduplication rate between the backup 204 and the data in the target backup server 220. If each data chunk is in the same size, the deduplication rate may be characterized by the same number of hashes. If some data chunks are not in the same size, the deduplication rate may be further determined by the same amount of data, where the deduplication rate represents a duplication rate between data. In general, the higher the deduplication rate is, the smaller the amount of data that needs to be replicated, and the more network and storage resources are saved.

At 304, a target server is selected from the first target server and the second target server based on the first deduplication rate and the second deduplication rate. For example, in the example backup 204 of FIG. 2, the first deduplication rate between the backup 204 and the data in the target backup server 210 is obviously smaller than the second deduplication rate between the backup 204 and the data in the target backup server 220. Therefore, in embodiments of the present disclosure, the target backup server 220 with a larger deduplication rate is selected by the data mining, as the selected suitable target backup server. In some embodiments, when there are more than two target backup servers, a target server with the maximum degree of duplication with the data backup to be performed may be selected from all target servers for the data backup.

At 306, a portion of data in the data backup is replicated to the selected target server. For example, in the example backup 204 of FIG. 2, a portion of data in the backup 204 is replicated to the target backup server 220 (for example, only the data chunk corresponding to the hash h13 needs to be replicated), rather than being replicated to the target backup server 210. In this way, the amount of data to be replicated during the backup process can be reduced.

Therefore, according to the embodiments of the present disclosure, it is possible to, by selecting the most suitable target server from a plurality of target servers through data mining, reduce the amount of data replicated during the data backup process, thereby reducing the time for data replication and reducing the loads and maintenance costs of the backup system.

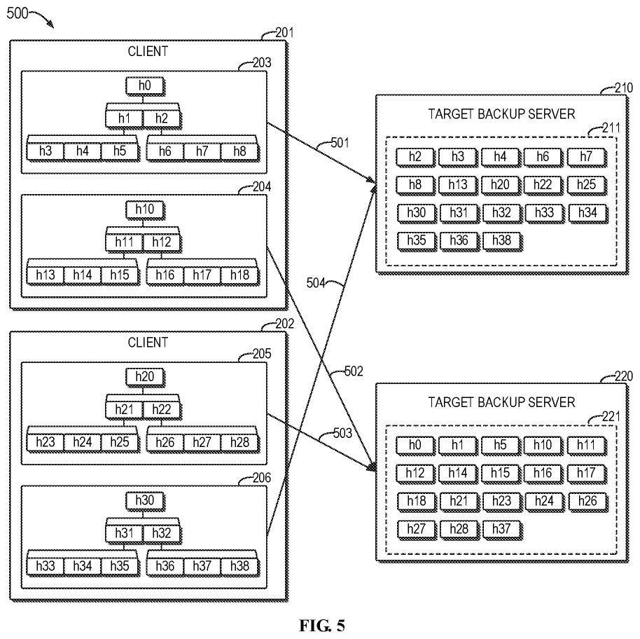

FIG. 4 shows a schematic diagram 400 of querying for hashes according to an embodiment of the present disclosure. In the example in FIG. 4, the data backup 402 in the source server 401 needs to be replicated to a target server for backup. In the example in FIG. 4, the target server is the server 410 or 420. In other embodiments, more than two target servers may exist. First, the data in the data backup 402 to be performed is divided into a plurality of data chunks, and the hash of each data chunk in the plurality of data chunks is determined. Any existing or to-be-developed data chunking algorithms and/or a hash algorithm may be used in combination with embodiments of the present disclosure. Next, the source server 401 sends a hash query message to the target server 410 and the target server 420, respectively, to query whether each hash of each data chunk in the data backup 402 exists on the target server 410 and the target service 420. After each target server completes the hash query, the hash query results are returned to the source server 401, respectively.

Certain processing time is needed in selecting the most suitable target server through the hash query. Therefore, in order to reduce the impact on time for data backup, a hash query may be performed in advance, for example, one backup cycle in advance. For example, assuming that the cycle of data backup is one day, that is, backup is performed once a day, the hash query and target server selection process may be performed on one day before the data backup 402 needs to be performed. In this way, the time for data backup will not be extended, thus ensuring the user experience.

In some embodiments, the replication is completed at least one replication cycle (e.g., one day in advance) earlier than the actual replication process. Therefore, the calculation of the optimal replication group is performed on the N^{th} day before the N+1^{th} day of the scheduled replication day. However, the time interval may also be adjusted according to the actual system scale. For example, if there are a large number of newly created backups each time, and the calculation of groups cannot be completed within one day, then the administrator may extend the interval to two days or more, and adjust the replication date of the source backup server 401 accordingly.

The source backup server 401 may calculate a deduplication rate with newly created backups (for example, data backup 402) for all the target backup servers 410 and 420, and determine the most suitable target backup server for each backup according to the deduplication rates. Therefore, the replication granularity of embodiments of the present disclosure is one backup (for example, one backup task), rather than all backups of the client, which is conducive to the integrity of the backup data as well as data deduplication and easy implementation. In some embodiments, on the N^{th} day, for each newly added data backup (e.g., data backup 402) that will not expire on the N+1^{th} day of the scheduled replication day, the source server 401 will send a hash query message, such as an “is_hash_present” message, to each target server (e.g., target servers 410, 420) for each of its hashes, unless the hash has been previously queried and stored in cache 403. After receiving the hash query message, the target servers 410 and 420 check whether the specified hash and its corresponding data chunk exist locally. Since the actual replication occurs on the N+1^{th} day of the query, it still needs to be ensured that the hash is still valid on the N+1^{th} day. Based on the hash query results of all target servers, the source server 401 may select the optimal target server for each backup (for example, data backup 402) by selecting a target server (for example, target server 420) with the highest hash deduplication rate. In some embodiments, the data deduplication rate may be determined based on the number of bytes of the stored data instead of the number of hashes.

In a hash-based system, a garbage collection (GC) function is usually used to recycle the storage space occupied by the expired backup data. Since the garbage collection will change the data on the server, some additional processing may need to be performed. In order to reduce the impact caused by garbage collection, in some embodiments, a hash query message may be sent to the target server after each target server has completed the garbage collection process of the current day. In addition, as the hash query is performed one day in advance, in order to ensure the validity of the hash on the N+1^{th} day (that is, not garbage collected), the target server only sets the hash corresponding to the data chunk that is not garbage collected on the N+1^{th} day to be a valid hash upon replication.

In the embodiments of the present disclosure, the processing about garbage collection need to comply with the following two criteria. First, the source server 401 will send the hash query message to query whether the hash exists only after the garbage collection is completed on all the target servers 410 and 420 on the N^{th} day, otherwise data chunks deleted during the garbage collection will cause the previous query results invalid. Second, if the real replication is scheduled after garbage collection on the target server on the N+1^{th} day, since the most suitable target server for each backup was calculated on the N^{th} day, some data on the target server may get expired on the N+1^{th} day and get deleted by the garbage collection, then the hash query result calculated on the N^{th} day will be invalid. Thus, the garbage collection on the target server needs some additional operations to handle this scenario.

A usual working manner of the garbage collection is as follows: first, the garbage collection will initialize a zero value for reference count of all the hashes saved in the backup system, then it will traverse all the valid backups which are not expired based on current time and increase the reference counts of hashes referred to by those still valid backups; then, the hashes whose reference count is still zero and the space occupied by its related data chunk will be released. In some cases, several rounds of above work may be needed until no zero-referred hashes exist.

In some embodiments, to make sure the hash query results obtained on the N^{th} day will still be valid on the N+1^{th} day when the real replication happens, a new flag called “StillValidOnReplication” may be used. During the special garbage collection on the target server, backups which will expire on the replication time on the N+1^{th} day will also be omitted, so the reference counts of hashes referred by those backups will not be increased, and finally the reference counts of hashes referred only by those backups will be zero, but those hashes and their data chunks will not be deleted actually. Flag “StillValidOnReplication” will be set to true for the hashes whose reference count is not zero to indicate this hash is still valid on the replication day. Reference is made below to Table 1 to check the example structure of hash elements.

TABLE 1
Flags of hashes used in the special garbage collection

| Hash | StillValidOnReplication | Other flag |
|---|---|---|
| 58b81ac7dd360bad274- | 0 | . . . |
| b501811456138a5ff7f4e | | |
| baf8292dd04ceb6e495c- | 1 | . . . |
| 18842d9222491d00f06d | | |
| . . . | . . . | . . . |

With the “StillValidOnReplication” flag in Table 1, when the source server 401 sends a message to query whether a certain hash or some hashes is still valid in the target servers 410 and 420 on the replication day, the target servers 410 and 420 will return the query result only when the hash is still valid upon replication with this flag on. This special garbage collection and flag will guarantee the query result of each hash is still valid in the future when the real replication happens.

Once the special garbage collection is done on the target server 410 or 420, it will send a notification to the source server 401 to indicate that the hash query may be executed. When all the connected target servers have finished the garbage collection, the source server 401 will start to query the hashes involved in the backup. The newly-added backups since last replication are inserted to a backlog queue. Then, those new backups will be handled one by one by traversing each of them, and the hash query message will be sent for each hash in the backup to each target server. To accelerate the query process, the query results will be saved in the cache 403 at the source server 401. Based on different system scales, the bytes used to record whether the hash exists in target servers may be different, for example, 1 byte may represent 8 target servers, and value 1 in a bit means the hash exists on the target server while 0 means that the hash does not exist on the target server.

After receiving all the hash query results, the source server 401 saves the hash query results of the respective target servers in the cache 403. The subsequent backup hash queries may refer to this cache 403 to speed up the query time. The system does not need to provide a lot of memory space for this purpose. For example, it may employ a manner such as the least recently used (LRU) and least frequently used (LFU). Then, the source server 401 determines the deduplication rate between the data backup 402 and the data in each target server according to the data in the cache 403, and selects a target server with the highest deduplication rate as the target server for the data backup 402 to be replicated. In this way, the most suitable target server for data backup 402 can be selected, the amount of data replicated during the backup process can be reduced, and the performance of the backup system can be improved.

In addition, the data on each target server will be dynamically changed along with the scheduled data replication, since the previously handled backup data from the source server will be replicated on the real replication day. Therefore, after the most suitable target server has been determined for the data backup 402, the cache 403 may be dynamically updated, and a “Non-replaced” flag is added to the table of the cache 403 to indicate that these hash query results should not be replaced. For example, one or more data chunks of the data backup 402 that need to be replicated to the selected target server are determined, and then the hash query results of one or more hashes of the one or more data chunks are updated in the cache 403. Table 2 below shows examples of dynamic changes in hash query results for two scenarios.

TABLE 2
Examples of dynamic changes in hash query results in the cache

| | Target | Target | Target | Target | Target | Target | Target | Target | |
|---|---|---|---|---|---|---|---|---|---|
| | Server | Server | Server | Server | Server | Server | Server | Server | Non- |
| Hash | 0 | 1 | 2 | 3 | 4 | 5 | 6 | 7 | replaced |
| 58b81ac7dd360bad274 | 0 | 1 | 0 | 0 | 1 | 1 | 0 | 0 | 0 |
| b501811456138a5ff7f4e | | | | | | | | | |
| baf8292dd04ceb6e495c | 0 | 0→1 | 0 | 0 | 0 | 0 | 0 | 0 | 0→1 |
| 18842d9222491d00f069 | | | | | | | | | |
| 20f2b1186fec751d614b | 0 | 1 | 0→1 | 0 | 0 | 0 | 0 | 0 | 0→1 |
| 9244ae2eb7faac026074 | | | | | | | | | |

As shown in the above Table 2, a scenario of dynamic changes of the hash query results in the cache is that the hash “baf8292dd04ceb6e495c18842d9222491d00f069” does not exist on any target server previously, but target server 1 is the previously calculated most suitable target server of the data backup of the hash. Therefore, due to the planned future replication, there will be the hash and its corresponding data chunk on the target server 1 on the replication day, so a bit which indicates whether the hash exists on the target server 1 will change from 0 to 1 to show this change.

Another scenario is that the hash “20f2b1186fec751d614b9244ae2eb7faac026074” exists only on the target server 1 previously, but the target server 2 is the previously calculated most suitable target server for the data backup involving the hash. Therefore, due to the planned future replication, there will also be the hash and its corresponding data chunk on the target server 2 on the replication day, so a bit which indicates whether the hash exists on the target server 2 will change from 0 to 1 to show this change.

When the most suitable target server is selected for subsequent data backup, it is unnecessary to send a corresponding hash query message to each target server, for the hashes that already exist in the cache 403. However, for hashes that do not exist in the cache 403, it is still necessary to send a query message to each target server, and update the hash query result into the cache 403.

FIG. 5 shows a schematic diagram 500 of data backup based on the data mining according to an embodiment of the present disclosure. In the example of FIG. 5, after all the hashes involved in a certain backup have been provided with the hash query results, the backup system can determine the most suitable target server for the backup based on the number of same hashes, namely, find a target server having the most same hashes in number.

As compared with FIG. 2, according to the backup method based on data mining according to the embodiment of the present disclosure shown in FIG. 5, the most suitable target backup server can be selected for each backup, thereby improving the performance of the storage system. Refer to FIG. 5, as shown by arrow 501, the backup 203 of the client 201 will select its most suitable target backup server 210; as shown by the arrow 502, the backup 204 of the client 201 will select its most suitable target backup server 220. As shown by arrow 503, the backup 205 of the client 202 will select its most suitable target backup server 220; as shown by arrow 504, the backup 206 of the client 202 will select its most suitable target backup server 210. As compared with FIG. 2, in the replication grouping manner shown in FIG. 5, the data chunks to be transmitted are significantly reduced, that is, only a very small portion of data chunks needs to be replicated to the target server. Therefore, according to the embodiments of the present disclosure, it is possible to, by selecting the most suitable target server from a plurality of target servers through data mining, reduce the amount of data transmitted during the data backup, thereby reducing the time for data replication, and reducing the loads and maintenance costs of the backup system.

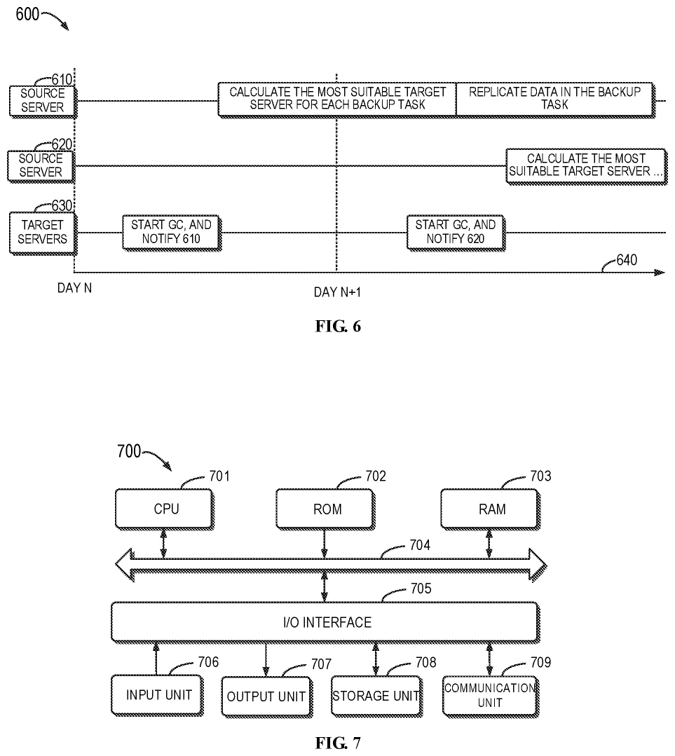

FIG. 6 shows a timing diagram 600 of a data backup process according to an embodiment of the present disclosure, where 640 represents a time axis. FIG. 6 shows a scenario in which a plurality of source servers 610 and 620 are connected to the same plurality of target servers 630, and it needs a reasonable way to avoid mutual influence. On the N^{th} day, the plurality of target servers 630 start to perform their respective garbage collection operations respectively, and notify the source server 610 to query the hash after completing the garbage collection. Then, the source server 610 calculates the most suitable target server for each backup task respectively by sending the hash query message to each target server 630 for each backup to be performed on the N+1^{th} day, until calculations of all the backup tasks are completed. Then, on the N+1^{th} day, the source server 610 may replicate the data in each backup task to the most suitable target server according to the calculation result on the N^{th} day.

Likewise, on the N+1^{th} day, the plurality of target servers 630 respectively start to perform their respective garbage collections, and notify the source server 620 that the hash may be queried, after completing the garbage collection. Similarly, the source server 620 respectively calculates the most suitable target server for each backup task by sending the hash query message to each target server for each backup to be performed on the N+2^{th} day, until calculations of all the backup tasks are completed. Then, on the N+2^{th} day, the source server 620 may replicate the data in each backup task to the most suitable target server according to the calculation result on the N+1^{th} day. It should be understood that the timing diagram of FIG. 6 is merely an example of the present disclosure, and is not intended to limit the scope of the present disclosure.

FIG. 7 shows a schematic block diagram of a device 700 that may be used to implement embodiments of the present disclosure. The device 700 may be the device or apparatus as described in embodiments of the present disclosure. As shown in FIG. 7, the device 700 comprises a central processing unit (CPU) 701 that may perform various appropriate acts and processing based on computer program instructions stored in a read-only memory (ROM) 702 or computer program instructions loaded from a storage unit 708 to a random access memory (RAM) 703. In the RAM 703, there further store various programs and data needed for operations of the device 700. The CPU 701, ROM 702 and RAM 703 are connected to each other via a bus 704. An input/output (I/O) interface 705 is also connected to the bus 704.

Various components in the device 700 are connected to the I/O interface 705, including: an input 706 such as a keyboard, a mouse and the like; an output unit 707 including various kinds of displays and a loudspeaker, etc.; a storage unit 708 including a magnetic disk, an optical disk, and etc.; a communication unit 709 including a network card, a modem, and a wireless communication transceiver, etc. The communication unit 709 allows the device 700 to exchange information/data with other devices through a computer network such as the Internet and/or various kinds of telecommunications networks.

Various processes and processing described above may be executed by the processing unit 701. For example, in some embodiments, the method may be implemented as a computer software program that is tangibly embodied on a machine readable medium, e.g., the storage unit 708. In some embodiments, part or all of the computer programs may be loaded and/or mounted onto the device 700 via ROM 702 and/or communication unit 709. When the computer program is loaded to the RAM 703 and executed by the CPU 701, one or more steps of the method as described above may be executed.

In some embodiments, the method and process described above may be implemented as a computer program product. The computer program product may include a computer readable storage medium which carries computer readable program instructions for executing aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

These computer readable program instructions may be provided to a processing unit of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for backing up data, comprising:
determining, for a data backup to be performed, a first deduplication rate related to a first target server and a second deduplication rate related to a second target server;
selecting a target server from the first target server and the second target server based on the first deduplication rate and the second deduplication rate; and
replicating a portion of data in the data backup to the selected target server.

2. The method according to claim 1, wherein selecting the target server from the first target server and the second target server comprises:
selecting, from a plurality of target servers, a target server having a maximum degree of duplication with the data backup, wherein the plurality of target servers at least comprising the first target server and the second target server.

3. The method according to claim 1, wherein determining that the first deduplication rate related to the first target server and the second deduplication rate related to the second target server comprises:
dividing data in the data backup into a plurality of data chunks;
obtaining a hash value of each data chunk in the plurality of data chunks to obtain a plurality of hash values;
sending a hash query message to each of the first target server and the second target server to query which of the plurality of hash values exist on the first target server and the second target server; and
determining the first deduplication rate and the second deduplication rate based on a hash query result, wherein the hash query result is received in response to the hash query message.

4. The method according to claim 3, wherein:
determining the first deduplication rate and the second deduplication rate comprises determining the first deduplication rate and the second deduplication rate at a first time; and
replicating the portion of data in the data backup to the selected target server comprises replicating the portion of data in the data backup to the selected target server at a second time, the first time being a predetermined time before the second time.

5. The method according to claim 4, wherein the sending the hash query message to the first target server and the second target server comprises:
in response to both the first target server and the second target server completing garbage collection at the first time, sending the hash query message to each of the first target server and the second target server; and
setting, by the first target server and the second target server, a hash value corresponding to a data chunk that is not garbage collected at the second time as a valid hash value upon replication.

6. The method according to claim 3, wherein the method further comprises:
storing the hash query result from the first target server and the second target server in a cache.

7. The method according to claim 6, wherein the selecting the target server from the first target server and the second target server comprises:
determining one or more data chunks in the data backup that need to be replicated to the selected target server; and
updating, based on the determination, one or more hash values corresponding to the one or more data chunks in the cache.

8. The method according to claim 7, wherein the data backup to be performed is a first data backup, and the method further comprises:
for a second data backup to be performed:
in response to a first hash value of a first data chunk in the second data backup existing in the cache, not sending any hash query message for the first hash value to the first target server and the second target server; and
in response to a second hash value of a second data chunk in the second data backup missing in the cache, sending a hash query message for the second hash value to each of the first target server and the second target server.

9. An electronic device, comprising:
a processing unit; and
a memory coupled to the processing unit and storing instructions thereon, the instructions, when executed by the processing unit, performing a method, the method comprising:
determining, for a data backup to be performed, a first deduplication rate related to a first target server and a second deduplication rate related to a second target server;
selecting a target server from the first target server and the second target server based on the first deduplication rate and the second deduplication rate; and
replicating a portion of data in the data backup to the selected target server.

10. The device according to claim 9, wherein selecting the target server from the first target server and the second target server comprises:
selecting, from a plurality of target servers, a target server having a maximum degree of duplication with the data backup, wherein the plurality of target servers at least comprising the first target server and the second target server.

11. The device according to claim 9, wherein determining that the first deduplication rate related to the first target server and the second deduplication rate related to the second target server comprises:
dividing data in the data backup into a plurality of data chunks;
obtaining a hash value of each data chunk in the plurality of data chunks to obtain a plurality of hash values;
sending a hash query message to each of the first target server and the second target server to query which of the plurality of hash values exist on the first target server and the second target server; and
determining the first deduplication rate and the second deduplication rate based on a hash query result, wherein the hash query result is received in response to the hash query message.

12. The device according to claim 11, wherein:
determining the first deduplication rate and the second deduplication rate comprises determining the first deduplication rate and the second deduplication rate at a first time; and
replicating the portion of data in the data backup to the selected target server comprises replicating the portion of data in the data backup to the selected target server at a second time, the first time being a predetermined time before the second time.

13. The device according to claim 12, wherein the sending the hash query message to the first target server and the second target server comprises:
in response to both the first target server and the second target server completing garbage collection at the first time, sending the hash query message to each of the first target server and the second target server; and
setting, by the first target server and the second target server, a hash value corresponding to a data chunk that is not garbage collected at the second time as a valid hash value upon replication.

14. The device according to claim 11, wherein the method further comprises:
storing the hash query result from the first target server and the second target server in a cache.

15. The device according to claim 14, wherein the selecting the target server from the first target server and the second target server comprises:
determining one or more data chunks in the data backup that need to be replicated to the selected target server; and
updating, based on the determination, one or more hash values corresponding to the one or more data chunks in the cache.

16. The device according to claim 15, wherein the data backup to be performed is a first data backup, and the method further comprises:
for a second data backup to be performed:
in response to a first hash value of a first data chunk in the second data backup existing in the cache, ceasing to not sending any hash query message for the first hash value to the first target server and the second target server; and
in response to a second hash value of a second data chunk in the second data backup missing in the cache, sending a hash query message for the second hash value to each of the first target server and the second target server.

17. A computer program product tangibly stored on a non-transitory computer readable medium and comprising computer-executable instructions, the computer-executable instructions, when executed, causing a computer to perform a method, the method comprising:
determining, for a data backup to be performed, a first deduplication rate related to a first target server and a second deduplication rate related to a second target server;
selecting a target server from the first target server and the second target server based on the first deduplication rate and the second deduplication rate; and
replicating a portion of data in the data backup to the selected target server.

18. The computer program product of claim 17, wherein selecting the target server from the first target server and the second target server comprises:
selecting, from a plurality of target servers, a target server having a maximum degree of duplication with the data backup, wherein the plurality of target servers at least comprising the first target server and the second target server.

19. The computer program product of claim 17, wherein determining that the first deduplication rate related to the first target server and the second deduplication rate related to the second target server comprises:
dividing data in the data backup into a plurality of data chunks;
obtaining a hash value of each data chunk in the plurality of data chunks to obtain a plurality of hash values;
sending a hash query message to each of the first target server and the second target server to query which of the plurality of hash values exist on the first target server and the second target server; and
determining the first deduplication rate and the second deduplication rate based on a hash query result, wherein the hash query result is received in response to the hash query message.

20. The computer program product of claim 19,
determining the first deduplication rate and the second deduplication rate comprises determining the first deduplication rate and the second deduplication rate at a first time; and
replicating the portion of data in the data backup to the selected target server comprises replicating the portion of data in the data backup to the selected target server at a second time, the first time being a predetermined time before the second time.
